(19) United States
(12) Patent Application Publication
(10) Pub. No.: US 2005/0035032 A1
(43) Pub. Date: Feb. 17, 2005

(54) System and method for processing waste and recovering recyclable materials

(76) Inventor: David P. McGee, Sagamore Hills, OH (US)

Correspondence Address: DEVINE, MILLIMET & BRANCH, P.A., 111 AMHERST STREET, BOX 719, MANCHESTER, NH, 03105, US

(21) Appl. No.: 10/887,339

(22) Filed: Jul. 8, 2004

Related U.S. Application Data
(60) Provisional application No. 60/485,920, filed on Jul. 8, 2003.

(51) Int. Cl. B07B 9/00

(52) U.S. Cl. 209/309; 209/930

(57) ABSTRACT

A system and method is provided for recovering recyclable materials from waste material. In general, the method includes the steps of feeding the waste material onto a high gravity force and separating the waste material by size and characteristic using the high gravity force. The system and method can be used to recover recyclable materials from municipal solid waste, landfill reclamation waste, and/or construction waste.

### CROSS-REFERENCE TO RELATED APPLICATIONS

The present application claims the benefit of provisional patent application Ser. No. 60/485,920 filed Jul. 8, 2003, which is incorporated herein by reference.

### TECHNICAL FIELD

The present invention relates to recovering recyclable materials and more particularly, to a system and method for recovering recyclable materials from municipal solid waste (MSW), landfill reclamation waste (LRW) and construction.

### BACKGROUND OF THE INVENTION

Concerns about natural resources and the environment have led to increasing recycling efforts. Different types of materials (e.g., metals, plastics, etc.) typically require different recycling processes. Although many people make an effort to separate such materials to facilitate the recycling process, the various types of recyclable materials often are mixed together in waste materials, such as municipal solid waste (MSW), landfill reclamation waste (LRW), construction waste and other waste. Thus, there is a need to segregate and separate the recyclable materials from the waste material in order to recover the recyclable material. By more efficiently recovering the recyclable materials from waste material, the volume and weight of waste material sent to the landfill can be reduced and transportation and disposal costs can be minimized.

Existing systems and method for recovering recyclable materials from waste often do not efficiently segregate and separate the different types of recyclable materials. The through-put capacity of these systems is also limited. Many of the limitations of these existing systems result from the type of feeder equipment and screening equipment used.

To feed the waste material, some existing systems use an apron conveyor, which does not adequately segregate the material being fed. Also, bulk loading does not adequately spread on the conveyor, compromising metering. Other systems use a natural frequency feeder, which feeds using a fixed vibrating stroke angle and a vibration frequency limited by the spring natural frequency. This type of feeder runs at a relatively low G force and also does not adequately feed the material.

To screen the waste material, some existing systems and methods use a rotating trommel screen. The trommel screen is large and expensive to acquire and maintain and “fluffs” the material, making it more difficult to process the material with downstream equipment. Furthermore, the trommel screen makes it more difficult to later process and pick out the recyclable materials because MSW material is degraded and like materials are mixed, not segregated, by the trommel screen. The trommel screen is also susceptible to shock load damage due to non-isolated construction.

Other existing systems use a natural frequency finger type feeder/conveyor that provides a fixed vibrating stroke angle and vibration frequency limited by spring natural frequency. This existing equipment runs at a relatively low G force, promoting “blinding” or plugging of materials on smaller openings. When using the natural frequency finger type feeder, small material is inefficiently separated from larger material due to the heavy overburden of oversized materials. As a result of this condition, additional length and larger equipment is required. Furthermore, the natural frequency finger type feeder units have many moving parts requiring increased maintenance and upkeep.

Other existing systems use a disc screen. These units also have many moving parts requiring increased maintenance and upkeep. The construction of the disc screen promotes material wrapping around equipment requiring increased clean-up, which is difficult and time consuming. Furthermore this, equipment is susceptible to shock load damage due to non-isolated construction.

Accordingly, there is a need for a system and method of recovering recyclable materials from waste material more efficiently and cost effectively than the existing systems discussed above.

### SUMMARY OF THE INVENTION

In accordance with one aspect of the present invention, a method is provided for recovering recyclable materials from waste material. In general, the method includes the steps of feeding the waste material onto a high gravity force, and separating the waste material by size and characteristic using the high gravity force. Some embodiments of this method may include one or more of the following: where the waste material is municipal solid waste; where the waste material is landfill reclamation waste; where the waste material is construction waste; where the high gravity force has a gravitational force of at least about 3; and where the high gravity force is a brute force vibrating multi-surface screen.

In accordance with another aspect of the present invention, a method is provided for recovering recyclable material from municipal solid waste, landfill reclamation waste or construction waste. The method includes the steps of feeding the municipal solid waste, landfill reclamation waste or construction waste onto a high gravity force, and separating the municipal solid waste, landfill reclamation waste or construction waste by size and characteristic using the high gravity force. Some embodiments of this method may include where the high gravity force has a gravitational force of at least about 3.

In accordance with another aspect of the present invention, a method is provided for recovering recyclable materials from waste material. This method includes the steps of feeding the waste material using a high gravity force, separating the waste material into separate streams by size and characteristic using a high gravity force and separately conveying the separate processing streams.

Some embodiments of this method may include one or more of the following: where the high gravity force has a gravitational force of at least about 3; where the feeding further includes feeding using a high gravity force vibrating feeder; and where the separating further includes conveying said waste material to a multi-surface vibrating screen.

In accordance with another aspect of the present invention, a method is provided for recovering recyclable materials from waste material. The method includes the steps of feeding the waste material using a high gravity force vibrating feeder, receiving the waste material from the vibrating feeder, conveying the waste to a multi-surface vibrating screen, separating the waste material into separate streams by size and characteristic using a high gravity force, and separately conveying the waste material of different sizes and characteristics to separate processing streams.

Some embodiments of this method may include one or more of the following: where the vibrating feeder is a brute force vibrating pan feeder; where the pan feeder rests on at least four steel coil springs whereby the pan feeder is isolated from shock damage; where the high gravity force is generated by an exciter means; and where the said exciter means has adjustable vibrating stroke angles. Additionally, some embodiments of this method may include one or more of the following: where the exciter means are paired unbalanced shafts uncoupled and driven by vibrating or non-vibrating motors; where the exciter means are paired unbalanced shafts coupled and driven by a vibrating or non-vibrating motors; where the exciter means are paired unbalanced flywheels uncoupled and driven by vibrating or non-vibrating motors; where the exciter means are paired unbalanced flywheels coupled and driven by a vibrating or non-vibrating motor; where the receiving step further includes an infeed conveyor that runs at a faster speed than the vibrating feeder; and where the multi-surface screen is a modular vibrating multi-surface screen.

In accordance with another aspect of the present invention, a system is provided for recovering recyclable materials from waste material. The system includes a vibrating feeder for receiving and feeding waste material, and an infeed conveyor connected to the vibrating feeder that receives the waste material from the vibrating feeder and conveys the waste material to a modular vibrating multi-surface screen connected to the infeed conveyor. The modular vibrating multi-surface screen exerts a high gravity force onto the waste material to separate the waste material into distinctly separate processing streams by size and characteristic. The system also includes a plurality of conveyors connected to the modular vibrating multi-surface screen. The conveyors receive the separate processing streams of waste material of different sizes from the modular vibrating multi-surface screen.

Some embodiments of this system may include one or more of the following: where the modular vibrating multi-surface screen is a brute force vibrating multi-surface screen; where the infeed conveyor is an infeed uptake steel pan apron chain belt conveyor; and where the plurality of conveyors further comprising at least one over-sized material take away sorting conveyor, a middle-sized material take away transfer conveyor, a middle sized material take away sorting conveyor, and an under-sized material take away transfer conveyor. Some embodiments of this system may also include one or more of the following: where the plurality of conveyors conveys at a faster speed than the vibrating multi-surface screen; and where the system further includes at least one magnet positioned over each of the plurality of conveyors and a head pulley permanent magnet connected to a conveyor head pulley on said under-sized conveyor, where the magnets are positioned to remove ferrous particulate from the waste material. Additionally, some embodiments may also include an elevated platform adjacent to the plurality of conveyors, and/or a plurality of material drop chutes adjacent to the platform.

These aspects of the invention are not meant to be exclusive and other features, aspects, and advantages of the present invention will be readily apparent to those of ordinary skill in the art when read in conjunction with the appended claims and accompanying drawings.

### BRIEF DESCRIPTION OF THE DRAWINGS

These and other features and advantages of the present invention will be better understood by reading the following detailed description, taken together with the drawings wherein:

FIG. 1A is a flow diagram of the method of recovering recyclable materials, according to one embodiment of the present invention;

FIG. 1B is a top view of a system for recovering recyclable materials, according to one embodiment of the present invention;

FIG. 2 is a side view of the system shown in FIG. 1B;

FIG. 3 is a side view of one embodiment of a vibrating feeder used in the system shown in FIG. 1B;

FIG. 4 is an end view of the vibrating feeder shown in FIG. 3;

FIG. 5 is a side view of one embodiment of an infeed conveyor used in the system shown in FIG. 1B;

FIG. 6 is a top view of one embodiment of a vibrating multi-surface screen used in the system shown in FIG. 1B;

FIG. 7 is a side view of the vibrating multi-surface screen shown in FIG. 6;

FIG. 8 is a top view of one embodiment of the sorting conveyors used in the system shown in FIG. 1B; and

FIG. 9 is a side view of the sorting conveyors shown in FIG. 8.

### DETAILED DESCRIPTION OF THE PREFERRED EMBODIMENTS

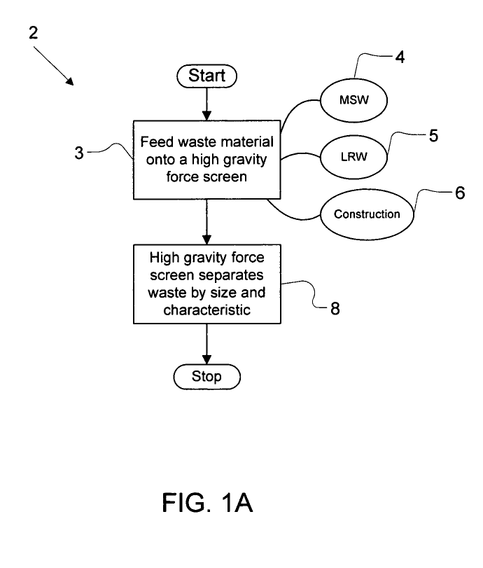

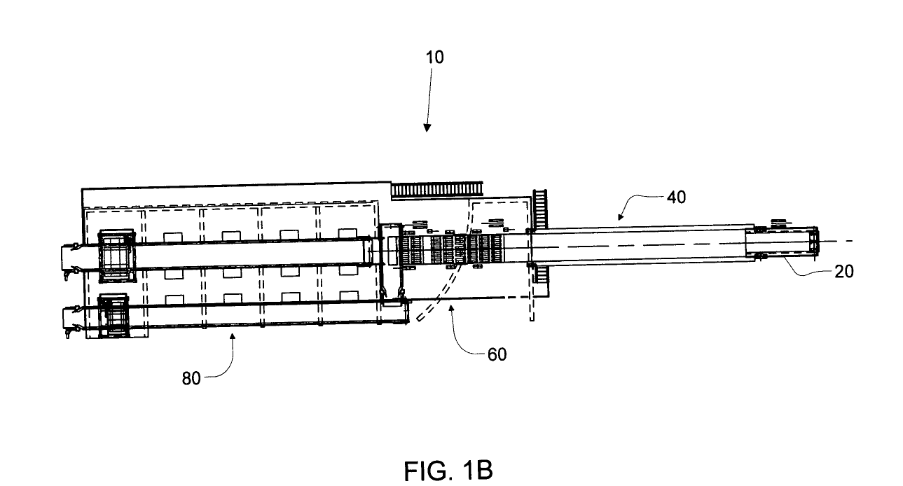

Referring first to FIG. 1A, the preferred embodiment of the method 2 for recovering recyclable waste material is shown. The preferred embodiment includes feeding waste onto a high gravity force screen 3 and separating the waste by size and characteristic using the high gravity force screen 8. The result is recovering recyclable materials from the waste fed into the screen. In one embodiment, the high gravity force screen is a “brute force” vibrating multi-surface screen and uses a gravitational force of about 3 or greater to separate the waste. In the preferred embodiment, the screen is a “brute force” modular vibrating multi-surface screen and has three surfaces. However, in other embodiments, the screen has two or more surfaces. The screens can have any size mesh suitable for the type of waste being separated. In the preferred embodiment, the “brute force” modular vibrating multi-surface screen is, from top to bottom, stacked screens varying from larger mesh to finer mesh. This design allows the larger waste to stay on the top, while the finer waste will flow-through the top screen and middle screen, and the finest waste will flow through to below the lowest screen. In other embodiments, the screen can have any number of surfaces two or greater, depending on the type of waste being separated. The waste can be fed onto the screen by any means known in the art.

The method can be used to recover recyclable materials from municipal solid waste (MSW) 4, landfill reclamation waste (LCW) 5, and /or construction waste 6 (construction). This method can also be used to recover recyclable materials from other types of waste where one wishes to recover recyclable materials.

Referring now to FIG. 1B, an exemplary embodiment of a system 10 for recovering recyclable material from waste material is described in greater detail. The system 10 includes a vibrating feeder 20 for receiving and feeding waste material, preferably using a high gravity force to segregate and substantially evenly feed the waste material. An infeed conveyor 40 receives the waste material from the vibrating feeder 20 and conveys the waste material to a modular vibrating multi-surface screen 60. The modular vibrating multi-surface screen 60 receives the waste material from the conveyor and uses a high gravity force to separate the waste material into distinctly separate processing streams by size and characteristic. A plurality of conveyors 80 receive separated waste material of different sizes from the modular vibrating multi-surface screen 60, allowing picking personnel to remove and separate different types of recyclable materials.

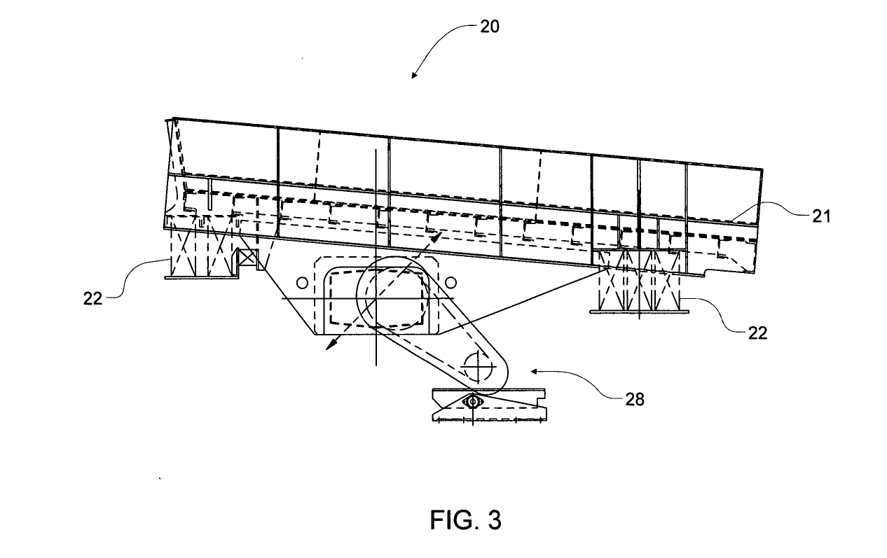

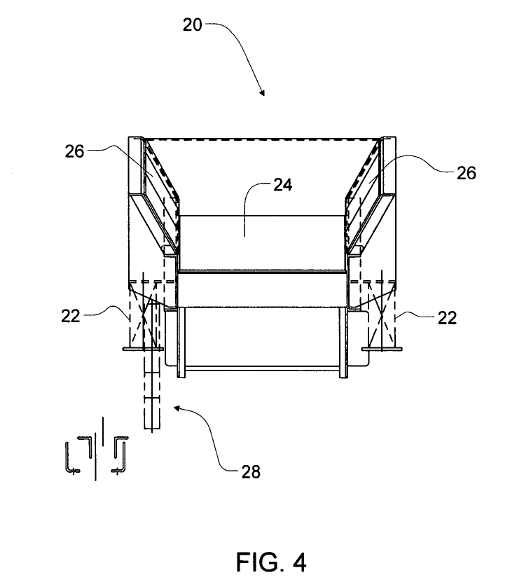

In the exemplary embodiment, the vibrating feeder 20, shown in FIGS. 3 and 4, is a “brute force” vibrating pan feeder. The pan feeder is preferably constructed in such a manner to accept large surge loads of bulk presorted waste materials by means of a wheeled loader, excavator and/or special material handler equipped with bucket, grapple or other attachment. The pan feeder is also preferably designed for rugged operation and is isolated from loader or material shock damage by having the entire vibrating body 21 resting on steel coil springs 22. The pan 24 and sides 26 can be lined with various materials depending on the operation (e.g., rubber, UHMW and/or steel).

The vibrating feeder 20 preferably uses a high gravity force to efficiently accept, meter, and segregate MSW and to mitigate glass breakage and material “fluffing” as well as evenly feed MSW to the downstream process equipment. In the exemplary embodiment, the high gravity force is greater than about 3 G's. The vibrating body 21 is preferably designed to withstand the preferred high gravity force.

The high gravity force can be generated by an exciter means 28. The exciter means 28 can include one or more of the following: paired unbalanced shafts uncoupled and driven by vibrating or non-vibrating motors; paired unbalanced shafts coupled and driven by a vibrating or non-vibrating motor; paired unbalanced flywheels uncoupled and driven by vibrating or non-vibrating motors; and paired unbalanced flywheels coupled and driven by a vibrating or non-vibrating motor. Additionally, the exciter means includes any means of creating high gravity force.

The advantages of using the above drive configurations for the exciter mechanism 28 is that the vibrating stroke angle, amplitude and speed can be easily adjusted to provide the maximum operational and mechanical efficiency. Other exciter mechanisms capable of generating the preferred high gravity force are also contemplated.

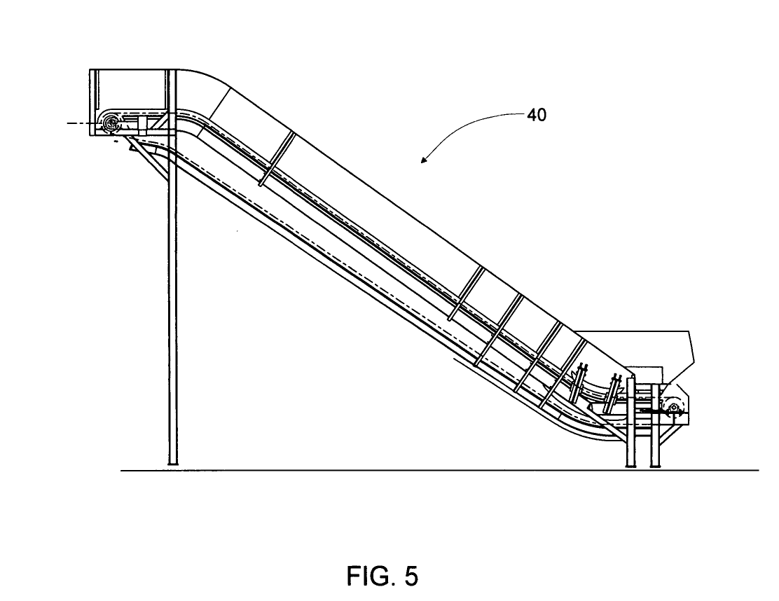

In the exemplary embodiment, the infeed conveyor 40, shown in FIG. 5, is an infeed up-take steel pan apron chain belt conveyor. This conveyor 40 is preferably constructed in such a manner to accept material from the vibrating feeder 20 and to run at a faster speed than the vibrating feeder 20 to improve the material separation and presentation to down stream equipment.

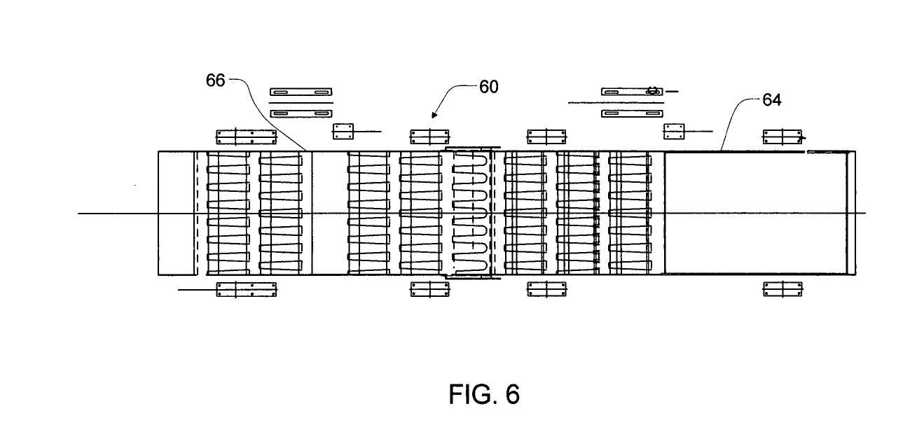

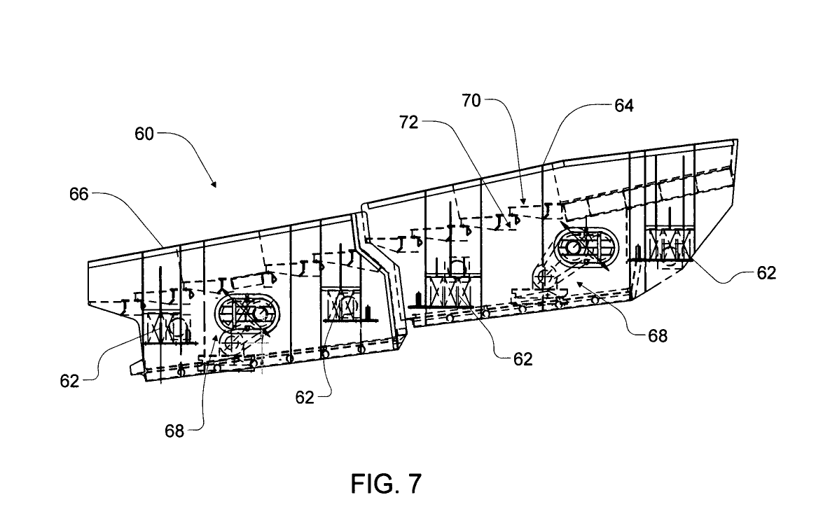

In the exemplary embodiment, the vibrating multi-surface screen 60, shown in FIGS. 6 and 7, is a modular “brute force” vibrating multi-surface screen. The screen 60 is preferably constructed in such a manner to accept presorted waste materials by means of the conveyor 40. The vibrating multi-surface screen 60 is preferably designed for rugged operation and is isolated from material shock damage by having the entire vibrating body 64, 66 resting on steel coil springs 62. In the preferred embodiment, at least 4 steel coil springs 62 are used. The pan and sides of the screen 60 can be lined with various materials depending on the operation (rubber, UHMW and/or steel).

The screen 60 can have any number of surfaces depending on the type of waste being processed. In the preferred embodiment, the screen has three surfaces, but the number of screens in other embodiments can be any number of surfaces 2 or greater. The screens preferably have decreasing mesh sizes from the top to bottom screen. The mesh sizes can be any size, depending on the type of waste being processed.

The vibrating modular multi-surface screen 60 preferably uses a high gravity force to efficiently accept, feed, segregate, and separate MSW, LRW and construction waste and to mitigate glass breakage and material “fluffing” as well as evenly feed MSW, LRW and construction waste to the downstream process equipment. In the exemplary embodiment, the high gravity force is greater than about 3 G's. The vibrating body 64, 66 is preferably designed to withstand the preferred high gravity force. The vibrating multi-surface screen 60 thus uses the high gravity force to efficiently process and separate MSW, LRW and construction waste into distinctly separate processing streams by size and characteristic, thereby further improving the efficiency of downstream equipment.

The high gravity force can be generated by an exciter mechanism 68. The exciter mechanism 68 can include one or more of the following: paired unbalanced shafts uncoupled and driven by vibrating or non-vibrating motors; paired unbalanced shafts coupled and driven by a vibrating or non-vibrating motor; paired unbalanced flywheels uncoupled and driven by vibrating or non-vibrating motors; and paired unbalanced flywheels coupled and driven by a vibrating or non-vibrating motor. Additionally, the exciter means includes any means of creating high gravity force.

The advantages of using the above drive configurations for the exciter mechanism 68 is that the vibrating stroke angle, amplitude and speed can be easily adjusted to provide the maximum operational and mechanical efficiency. Other exciter mechanisms capable of generating the preferred high gravity force are also contemplated.

The vibrating multi-surface screen 60 is preferably modular and includes a feed module 64 and a discharge module 66. By utilizing the modular design, the processing efficiency is heightened due to the fact that, as the material characteristics change after being processed on the feed module 64, the discharge module 66 can be set up differently to be progressively more efficient.

The modular vibrating multi-surface screen 60, in the preferred embodiment, also includes a top surface 70 and a bottom surface 72. In other embodiments, the modular vibrating multi-surface screen 60 includes more than 2 surfaces. Material larger than the top surface opening will remain on top of the top surface 70. Material smaller than the top surface opening but larger than the bottom surface opening will pass through the top surface 70 but remain on top of the bottom surface 72. Material smaller than the bottom surface opening will pass through both the top surface 70 and the bottom surface 72. Additional screen surfaces can be utilized depending on the operation.

Thus, the modular vibrating multi-surface screen 60 has advantages over the trommel screen, the natural frequency finger type feeder/conveyor, and the disc screen used in existing systems.

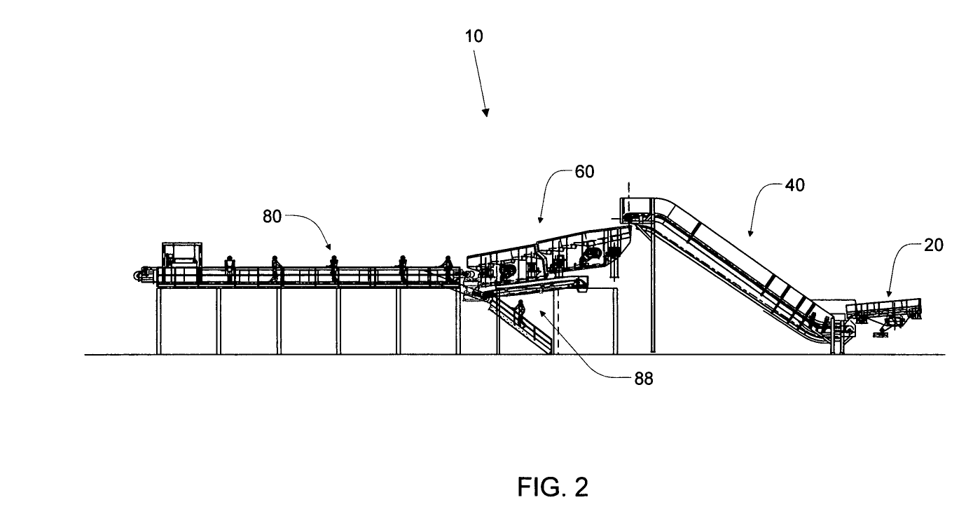

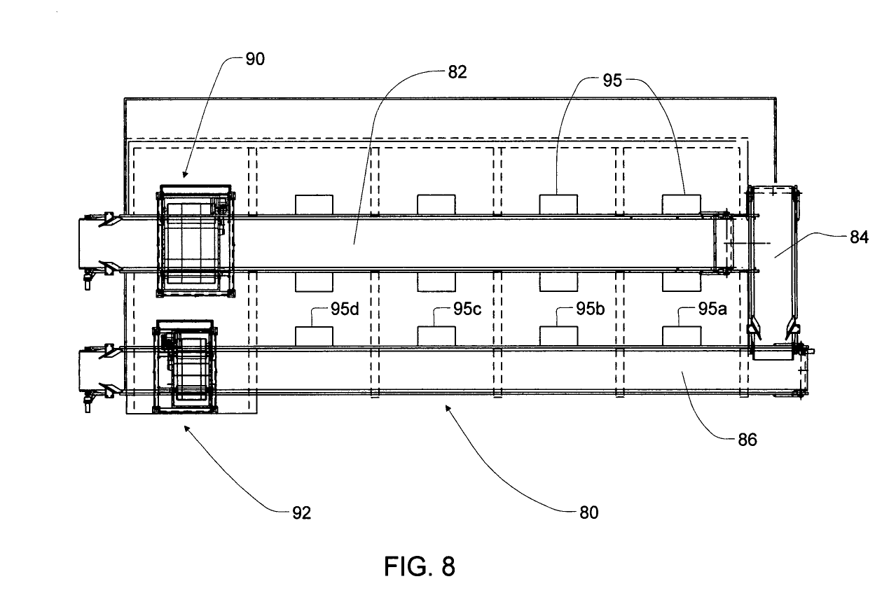

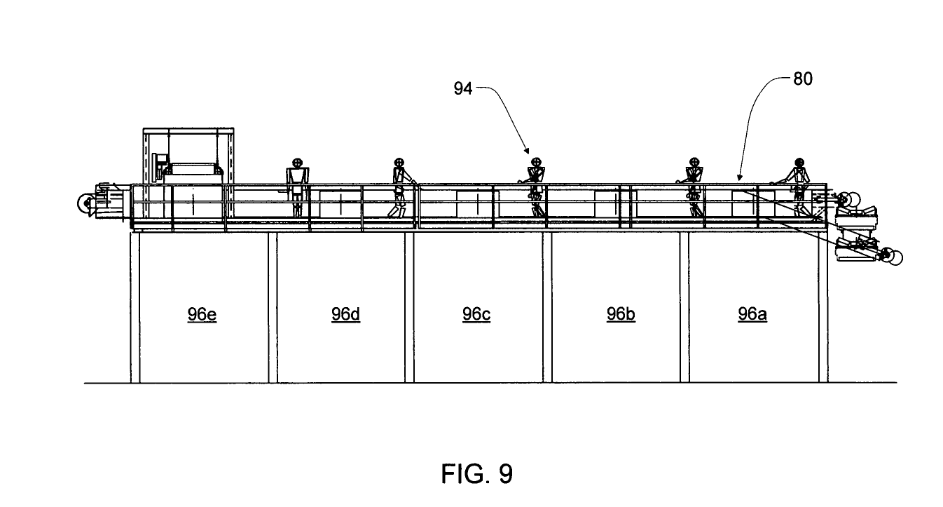

In the exemplary embodiment, the conveyors 80, shown in FIGS. 8 and 9, include an over-sized material take away sorting conveyor 82, a middle-sized material take away transfer conveyor 84, a middle sized material take away sorting conveyor 86, and an under-sized material take away transfer conveyor 88 (see FIG. 2).

The over-sized material take away sorting conveyor 82 is preferably constructed in such a manner to accept processed material from the screen 60, for example, the oversize material on the top screen surface 70. The over-sized material take away sorting conveyor 82 also preferably conveys at a faster speed than the screen 60 to improve the material separation and presentation to manual pickers and down stream equipment.

The middle sized material take away transfer conveyor 84 and sorting conveyor 86 are preferably constructed in such a manner to accept processed material from the screen 60, for example, the material that falls through the top screen surface 70 but not the bottom screen surface 72. The transfer conveyor 84 and the sorting conveyor 86 also preferably convey at a faster speed than the screen 60 to improve the material separation and presentation to manual pickers and down stream equipment.

The under-sized material take away transfer conveyor 88 (see FIG. 2) is preferably constructed in such a manner to accept processed material from the screen 60, for example, the material that falls through the bottom screen surface 72. The under-sized material take away transfer conveyor 88 also preferably conveys at a faster speed than the screen 60 to improve the material separation and presentation to down stream equipment.

The exemplary embodiment of the system 10 also includes an over band cross belt magnet 90 over the over-sized conveyor 82, an over band cross belt magnet 92 over the middle-sized conveyor 86, and a head pulley permanent magnet built into the conveyor head pulley on the under-sized conveyor 88. The magnets are preferably constructed and positioned in such a manner to remove ferrous particulate as the final stage of recovering recyclable materials. The magnetic separation equipment is located in optimum places to provide efficient and effective removal of ferrous metal. The type of magnet used depends on the waste being processed

The exemplary embodiment of the system 10 further includes an elevated sorting and picking personnel work platform 94. The platform 94 includes picking stations preferably designed for safety and to maximize manual sorting efficiency and effectiveness. Picking locations have material drop chutes 95a-95d positioned over the sorted material containment bunkers 96a-96d for hand sorted material segregation and containment.

While the principles of the invention have been described herein, it is to be understood by those skilled in the art that this description is made only by way of example and not as a limitation as to the scope of the invention. Other embodiments are contemplated within the scope of the present invention in addition to the exemplary embodiments shown and described herein. Modifications and substitutions by one of ordinary skill in the art are considered to be within the scope of the present invention.

1. A method for recovering recyclable materials from waste material, said method comprising the steps of:
feeding said waste material onto a high gravity force; and
separating said waste material by size and characteristic using said high gravity force.

2. The method claimed in claim 1 wherein said waste material is municipal solid waste.

3. The method claimed in claim 1 wherein said waste material is landfill reclamation waste.

4. The method claimed in claim 1 wherein said waste material is construction waste.

5. The method claimed in claim 1 wherein said high gravity force has a gravitational force of at least about 3.

6. The method claimed in claim 5 wherein said high gravity force is a brute force vibrating multi-surface screen.

7. A method for recovering recyclable material from municipal solid waste, landfill reclamation waste or construction waste, said method comprising the steps of:
feeding said municipal solid waste, landfill reclamation waste or construction waste onto a high gravity force; and
separating said municipal solid waste, landfill reclamation waste or construction waste by size and characteristic using said high gravity force.

8. The method claimed in claim 7 wherein said high gravity force has a gravitational force of at least about 3.

9. A method for recovering recyclable materials from waste material, said method comprising the steps of:
feeding said waste material using a high gravity force;
separating said waste material into separate streams by size and characteristic using a high gravity force; and
separately conveying said separate processing streams.

10. The method claimed in claim 9 wherein said high gravity force has a gravitational force of at least about 3.

11. The method claimed in claim 10 wherein said feeding further comprising feeding using a high gravity force vibrating feeder.

12. The method claimed in claim 11 wherein said separating further comprising conveying said waste material to a multi-surface vibrating screen.

13. A method for recovering recyclable materials from waste material, said method comprising the steps of:
feeding said waste material using a high gravity force vibrating feeder;
receiving said waste material from said vibrating feeder;
conveying said waste to a multi-surface vibrating screen;
separating said waste material into separate streams by size and characteristic using a high gravity force; and
separately conveying said waste material of different sizes and characteristics to separate processing streams.

14. The method claimed in claim 13 wherein said vibrating feeder is a brute force vibrating pan feeder.

15. The method claimed in claim 14 wherein said pan feeder rests on at least four steel coil springs whereby said pan feeder is isolated from shock damage.

16. The method claimed in claim 15 wherein said high gravity force is generated by an exciter means.

17. The method claimed in claim 16 wherein said exciter means has adjustable vibrating stroke angles.

18. The method claimed in claim 16 wherein said exciter means are paired unbalanced shafts uncoupled and driven by vibrating or non-vibrating motors.

19. The method claimed in claim 16 wherein said exciter means are paired unbalanced shafts coupled and driven by a vibrating or non-vibrating motors.

20. The method claimed in claim 16 wherein said exciter means are paired unbalanced flywheels uncoupled and driven by vibrating or non-vibrating motors.

21. The method claimed in claim 16 wherein said exciter means are paired unbalanced flywheels coupled and driven by a vibrating or non-vibrating motor.

22. The method claimed in claim 16 wherein said receiving step further comprising an infeed conveyor that runs at a faster speed than said vibrating feeder.

23. The method claimed in claim 16 wherein said multi-surface screen is a modular vibrating multi-surface screen.

24. A system for recovering recyclable materials from waste material, said system comprising:
a vibrating feeder for receiving and feeding waste material;
an infeed conveyor connected to said vibrating feeder that receives said waste material from said vibrating feeder and conveys said waste material to a modular vibrating multi-surface screen connected to said infeed conveyor, said modular vibrating multi-surface screen exerting a high gravity force onto said waste material to separate said waste material into distinctly separate processing streams by size and characteristic; and
a plurality of conveyors connected to said modular vibrating multi-surface screen, said conveyors receive said separate processing streams of waste material of different sizes from said modular vibrating multi-surface screen.

25. The system claimed in claim 24 wherein said modular vibrating multi-surface screen is a brute force vibrating multi-surface screen.

26. The system claimed in claim 24 wherein said infeed conveyor is an infeed uptake steel pan apron chain belt conveyor.

27. The system claimed in claim 24 wherein said plurality of conveyors further comprising:
at least one over-sized material take away sorting conveyor; a middle-sized material take away transfer conveyor; a middle sized material take away sorting conveyor; and an under-sized material take away transfer conveyor.

28. The system claimed in claim 27 wherein said plurality of conveyors conveys at a faster speed than said vibrating multi-surface screen.

29. The system claimed in claim 28 further comprising at least one magnet positioned over each of said plurality of conveyors and a head pulley permanent magnet connected to a conveyor head pulley on said under-sized conveyor, wherein said magnets are positioned to remove ferrous particulate from said waste material.

30. The system claimed in claim 29 further comprising an elevated platform adjacent to said plurality of conveyors.

31. The system claimed in claim 30 wherein said system further comprising a plurality of material drop chutes adjacent to said platform.
